(19) United States
(12) Patent Application Publication
(10) Pub. No.: US 2022/0164341 A1
(43) Pub. Date: May 26, 2022

(54) DISPLAYING DATA USING GRANULARITY CLASSIFICATION

(71) Applicant: International Business Machines Corporation, Armonk, NY (US)

(72) Inventors: Jian Jin, XIAN (CN); Feng Li, Xian (CN); Ying Bai, XIAN (CN); Ying Qiu Deng, XIAN (CN); Jia Tian Zhong, Beijing (CN)

(21) Appl. No.: 17/101,075

(22) Filed: Nov. 23, 2020

(51) Int. Cl. G06F 16/248; G06F 16/2457; G06F 16/2455

(52) U.S. Cl. CPC G06F 16/248; G06F 16/24552; G06F 16/24578

(57) ABSTRACT

A query on a data is received. One or more granularity of data is determined of the data to respond to the query. The one or more granularity of data includes a low granularity data and a high granularity data. Whether the low granularity data is stored in a cache is determined. Responsive to determining the low granularity data is stored in the cache, the low granularity data is retrieved. The low granularity data is displayed.

### BACKGROUND

The present invention relates generally to the field of displaying data, and more particularly to displaying data using granularity classification and cached data.

Data can be displayed in any form of graph or visual representation. Data can also be low granularity, for example yearly data, medium granularity, for example monthly data, or high granularity, for example daily data, or any other form of granularity between, below, or above the types noted here. Data displaying times can vary based on the amount of data that must be analyzed before being displayed.

### SUMMARY

Embodiments of the present invention disclose a method, a computer program product, and a system for visualization resonance for displaying data. In one embodiment, a query on a data is received. One or more granularity of data is determined of the data to respond to the query. The one or more granularity of data includes a low granularity data and a high granularity data. Whether the low granularity data is stored in a cache is determined. Responsive to determining the low granularity data is stored in the cache, the low granularity data is retrieved. The low granularity data is displayed.

### BRIEF DESCRIPTION OF THE DRAWINGS

FIG. 1 is a functional block diagram of a network computing environment, generally designated 100, suitable for operation of display program 112, in accordance with at least one embodiment of the invention.

FIG. 2 is a flow chart diagram depicting operational steps for display program 112 for displaying different granularities of data and caching of data, in accordance with at least one embodiment of the invention.

FIG. 3 is a flow chart diagram depicting operational steps for display program 112 for refreshing data in a cache, in accordance with at least one embodiment of the invention.

FIG. 4 is an example display of low granularity data, in accordance with at least one embodiment of the invention.

FIG. 5 is an example display of low granularity data and high granularity data, in accordance with at least one embodiment of the invention.

FIG. 6 is a block diagram depicting components of a computer, generally designated 600, suitable for executing display program 112, in accordance with at least one embodiment of the invention.

### DETAILED DESCRIPTION

The present invention provides a method, computer program product, and computer system for displaying different granularities of data and caching the data. The present invention provides a method, computer program product, and computer system for refreshing data in the cache for display.

Embodiments of the present invention recognize maintenance and presentation of data is crucial in an enterprise. However, users often cannot have a more intuitive impression of existing data when faced with intricate raw data. Displaying of data can often be very slow to load due to the large amount of data and often a large amount of time is required to render the final graphical display or sometimes the graphical display may not even load due to the amount of data. Embodiments of the present invention recognizes these problems can cause efficiency and usability issues for a user. Embodiments of the present invention solve this problem by improving performance and customer usability. Embodiments of the present invention provide a graphical display of the data from low granularity to high granularity and additionally use cached data to provide the graphical display quicker than traditional methods.

Embodiments of the present invention provide a method, computer program product, and computer system for acquiring and stored data from raw data. This provides support for extraction of key data at different levels of granularity and dimensions to obtain smaller and more intuitive granularity data than the raw data. Embodiments of the present invention provide for extracting data at different granularity and graphically displaying the coarse grained to fine data. For example, if a user wants to view a graph of data values for each day in a year, the user can first display the coarse grained display in units of years and then display the coarse grained display in months and then finally display in days. This example allows the user to not wait a long time for the day data to display but to quickly see the yearly data displayed first. This quickly shows the data, and allows the user to see changes in data and interrupt or continue the display depending on the needs of the user.

Embodiments of the present invention use hierarchical caching technology to customize coarse, medium, and fine grained (high vs low granularity data) according to the needs of the user and then then display program will generate these levels of data in a cache through aggregation queries. This can be done in real time or in advance. When a user queries data, certain granularities of data may already be stored in the cache and other granularities of data must be calculated for display. Both of these aspects (retrieving data from cache and analyzing the other granularities) can be done in parallel which improves efficiency of the system for display.

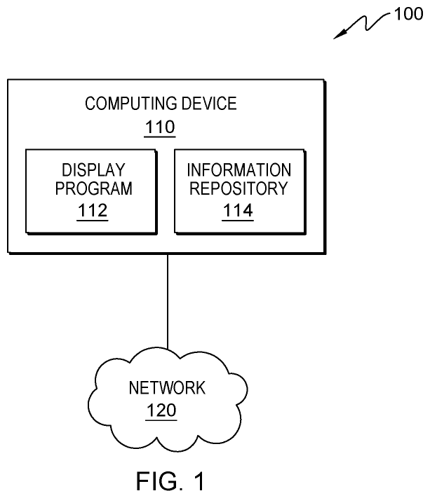

Referring now to various embodiments of the invention in more detail, FIG. 1 is a functional block diagram of a network computing environment, generally designated 100, suitable for operation of display program 112 in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes computing device 110 interconnected over network 120. In embodiments of the present invention, network 120 can be a telecommunications network, a local area network (LAN), a wide area network (WAN), such as the Internet, or a combination of the three, and can include wired, wireless, or fiber optic connections. Network 120 may include one or more wired and/or wireless networks that are capable of receiving and transmitting data, voice, and/or video signals, including multimedia signals that include voice, data, and video formation. In general, network 120 may be any combination of connections and protocols that will support communications between computing device 110 and other computing devices (not shown) within network computing environment 100.

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with other computing devices (not shown) within computing environment 100 via a network, such as network 120.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

In various embodiments of the invention, computing device 110 includes display program 112 and information repository 114.

In an embodiment, computing device 110 includes a user interface (not shown). A user interface is a program that provides an interface between a user and an application. A user interface refers to the information (such as graphic, text, and sound) a program presents to a user and the control sequences the user employs to control the program. There are many types of user interfaces. In one embodiment, a user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes display program 112. It should be noted, for ease of discussion, display program 112 is discussed in regard to “high granularity” and “low granularity” data. In other words, two levels of granularity of data. It is recognized that display program 112 may be implemented with any number of levels of granularity of data.

In a first embodiment, display program 112 receives a query on a set of data. In a first embodiment, display program 112 determines data to be provided for the received query. In a first embodiment, display program 112 determines whether there is high granularity data. In a first embodiment, display program 112 determines whether there is cached low granularity data. In a first embodiment, display program 112 gets the cached low granularity data. In a first embodiment, display program 112 calculates the low granularity data. In a first embodiment, display program 112 caches the low granularity data. In a first embodiment, display program 112 display the data. In a first embodiment, display program 112 calculates the high granularity data. In a first embodiment, display program 112 caches the high granularity data. In a first embodiment, display program 112 updates the displayed data.

In a second embodiment, display program 112 determine a last cache time. In a second embodiment, display program 112 determines the current time. In a second embodiment, display program 112 determines a delta between the last cache time and the current time. In a second embodiment, display program 112 determines whether the delta is greater than the cache interval times a threshold. In a second embodiment, display program 112 determines not to update the data. In a second embodiment, display program 112 determines the most recent data. In a second embodiment, display program 112 determines if the most recent data can be updated incrementally. In a second embodiment, display program 112 calculates all data. In a second embodiment, display program 112 determines the incremental update data. In a second embodiment, display program 112 calculates the new incremental update data. In a second embodiment, display program updates the cache and the last cache time.

In an embodiment, computing device 110 includes information repository 114. In an embodiment, information repository 114 may be managed by display program 112. In an alternative embodiment, information repository 114 may be managed by the operating system of computing device 110, another program (not shown), alone, or together with, display program 112. Information repository 114 is a data repository that can store, gather, and/or analyze information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided information repository 114 is accessible by computing device 110. Information repository 114 may include, but is not limited to, all data for display, cached data, cache interval, cache interval threshold, granularity thresholds for determining levels of granularity, information about what data is higher granularity vs lower granularity (for example, higher such as yearly data vs lower such as daily data), user defined granularity group (UDGG), etc. It should be noted, the UDGG is a user defined list of data that defines the granularity of each type of data and how each type of data is related to other types of data. For example, Data 1A is high granularity data. Data 1B is medium granularity data that is related to Data 1A. Data 1C is low granularity data that is related to Data 1A and 1B.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

As referred to herein, all data retrieved, collected, and used, is used in an opt-in manner, i.e., the data provider has given permission for the data to be used. For example, the data received and used by display program 112 analyzing and displaying.

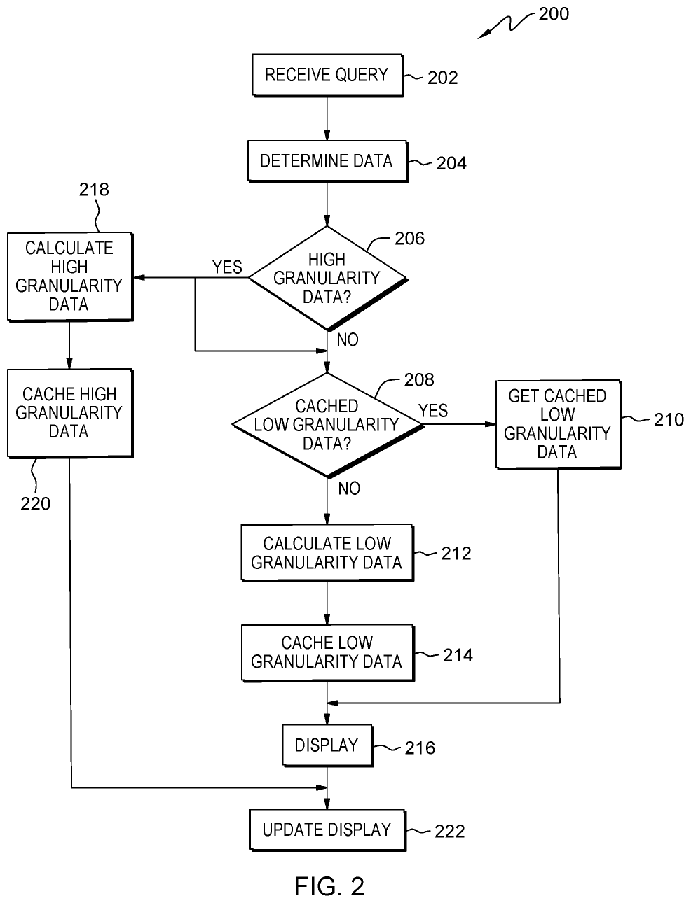

FIG. 2 is a flow chart diagram of workflow 200 depicting operational steps for display program 112 in accordance with at least one embodiment of the invention. In an alternative embodiment, the steps of workflow 200 may be performed by any other program while working with display program 112. It should be appreciated that embodiments of the present invention provide at least for displaying different granularities of data. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting display program 112 to display some of the data in response to a query on the data.

Display program 112 receives a query (step 202). At step 202, display program 112 receives a query on a set of data. In an embodiment, the query may be to display some or all of the set of data. In an embodiment, display program 112 may receive the query may be from a user via the user interface of computing device 110. In an alternative embodiment, display program 112 may receive the query from another program (not shown). For example, the query may be “Select avg(run_time) from tableA group by job_id, user_name, host_name.” Here the data is Table A and the query data is “job_id”.

Display program 112 determines data (step 204). At step 204, display program 112 determines the data to response to the query. In other words, display program 112 determines the data to display to answer the query received in step 202. In an embodiment, the data to display may be all of the set of data the query is accessing. In an alternative embodiment, the data to display may be some of the set of data the query is accessing. In an embodiment, display program 112 may determine the data using the UDGG. For example, the query data is “job_id” and the UDGG defines the high granularity data as “job_id” and this high granularity data has associated medium granularity data “queue” and low granularity data “cluster”.

Display program 112 determines whether the query includes high granularity data (decision step 206). At decision step 206, display program 112 determines whether the data in response to the query is high granularity data. In an embodiment, display program 112 uses the determination in step 204 and information found in the UDGG to determine if the data in response to the query is high granularity data. Responsive to display program 112 determining the query includes high granularity data (decision step 206, yes branch), processing proceeds to step 208 and step 218. Responsive to display program 112 determining the query does not include high granularity data (decision step 206, no branch), processing proceeds to step 208.

Display program 112 determines whether there is cached low granularity data (decision step 208). At decision step 208, display program 112 determines whether there is low granularity data, as determined in step 204, that is cached in information repository 114 or any other stored device accessible by display program 112. In a first embodiment, low granularity data may be only data that is classified in the UDGG as low granularity data. For an example of the first embodiment, the low granularity data is the “cluster” data. In a second embodiment, low granularity data may be any data that is not classified in the UDGG as high granularity data. For example in the second embodiment, the low granularity data may be “cluster” data and the “queue” data. Responsive to display program 112 determining there is cached low granularity data (decision step 208, yes branch), processing proceeds to step 210. Responsive to the display program 112 determining there is not any cached low granularity data (decision step 208, no branch), processing proceeds to step 212.

Display program 112 gets cached low granularity data (step 210). At step 210, display program 112 gets the cached low granularity data from information repository 114 or any other storage location accessible to display program 112 where the cached low granularity data is stored. In a first embodiment, display program 112 may request the data from the location the low granularity data is stored and then receive the cached low granularity data. In a second embodiment, display program 112 may access the location the low granularity data is stored for use in a subsequent display step (step 216).

Display program 112 calculates low granularity data (step 212). At step 212, display program 112 analyzes the set of data to determine the low granularity and organize/analyze/interpret the low granularity data for use in a subsequent display step (step 216). In an embodiment, display program 112 performs an aggregation on the determined data of step 204 to determine the low granularity data. In an embodiment, the aggregation functions include, but are not limited to, max, min, avg, count, sum, countd, stdev, stdevp, var, and varp. For example, the received query is “Select avg(run_time) from tableA group by job_id, user_name, host_name.”, and a UDGG is defined as (job_id:high granularity, queue:medium granularity, cluster:low granularity). Display program 112 runs sql “Select avg(run_time) from tableA group by cluster, user_name, host_name” as the low granularity data, run sql “Select avg(run_time) from tableA group by queue, user_name, host_name” as the medium granularity data, run sql “Select avg(run_time) from tableA group by job_id, user_name, host_name” as the medium granularity data.

Display program 112 caches low granularity data (step 214). At step 214, display program 112 stores the analyzed low granularity data of step 212 in information repository 114 or any other storage location accessible to display program 112.

Display program 112 displays (step 216). At step 216, display program 112 displays the data for the received query. In an embodiment, display program 112 displays the data in a graphical form on the user interface of computing device 110. In an embodiment, if the data for display is received from the cached low granularity data in step 210 as opposed to calculating the data using step 212, the display of the data happens at a faster rate due to the lack of need of analyzing the data.

Display program 112 calculates high granularity data (step 218). At step 218, display program 112 analyzes the set of data to determine the high granularity and organize/analyze/interpret the high granularity data for use in a subsequent update display step (step 222).

Display program 112 caches high granularity data (step 220). At step 220, display program 112 stores the analyzed high granularity data of step 218 in information repository 114 or any other storage location accessible to display program 112.

Display program 112 updates display (step 216). At step 216, display program 112 updates the display of the data for the received query to include high granularity data analyzed in step 218. In an embodiment, display program 112 displays the data in a graphical form on the user interface of computing device 110.

It should be noted, at any time the user may halt the operation of workflow 200. For example, if low granularity data is fully displayed (step 216), and then high granularity data is updating the display (step 218), the user may determine that they have viewed all they need in the data and the user may halt the operation of workflow 200, saving computing resources that may have been spent finishing the updating of the display (step 218).

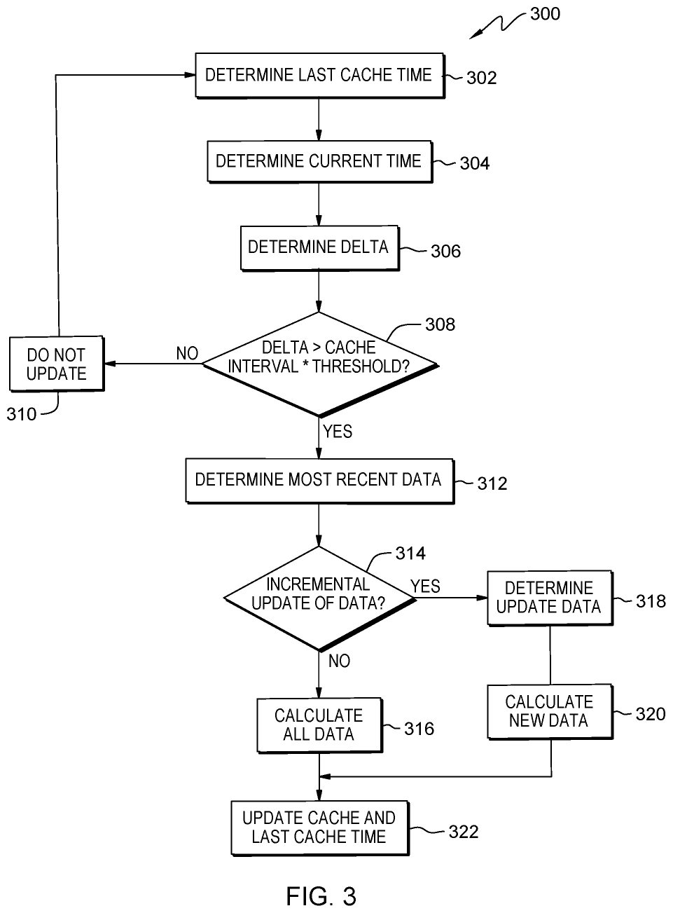

FIG. 3 is a flow chart diagram of workflow 300 depicting operational steps for display program 112 in accordance with at least one embodiment of the invention. In an alternative embodiment, the steps of workflow 300 may be performed by any other program while working with display program 112. It should be appreciated that embodiments of the present invention provide at least for updating caches of different granularities of data. However, FIG. 3 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 300 upon a user wanting display program 112 to update cache data. In an embodiment, any of the granularities of cached data can have workflow 300 performed in order to update the granularity of cached data. For example, both low granularity and high granularity data can have their cache updated using workflow 300.

Display program 112 determines the last cache time (step 302). At step 302, display program 112 determines the last time the data was updated that is stored in the cache. In other words, the last cache time is the time the most recent data was updated. For example, T1 is the time the most recent data was updated, T2 is the time the most recent data was analyzed (step 212 or 218), and T3 is the time the most recent data was added to the cache. In this example, the last cache time is T3 or the time the most recent data was added to the cache. In an embodiment, display program 112 may determine the last cache time by querying a program (not shown) that manages the cache or the operating system of the computing device that manages the cache and, in response, display program 112 receives the last cache time. In an embodiment, display program 112 may analyze the metadata associated with the set of data to determine the time of the last update to the data.

Display program 112 determines the current time (step 304). At step 304, display program 112 determines the current time by querying the operating system of computing device 110, the internet via network 120, or using any other known method in the art to determine the current time.

Display program 112 determines the delta (step 306). At step 306, display program 112 determines delta between the last cache time and the current time. In an embodiment, display program 112 uses the information determined in step 302 and step 304 and determines the difference between the last cache time (step 302) and the current time (step 304) and the differences is the delta.

Display program 112 determines whether the delta is larger than the cache interval times the threshold (decision step 308). At decision step 208, display program 112 determines whether the delta determined in step 306 is larger than the cache interval times the threshold. In a first embodiment, the cache interval and/or the threshold are found in information repository 114. In a second embodiment, the cache interval and/or the threshold are received via user input to computing device 110. In an embodiment, the cache interval is a time period that is specific to a piece of data, regardless of its granularity. In an embodiment, the threshold is a time period that is applied to all caching updates done by display program 112. In other words, the cache interval is data specific while the threshold is global. Responsive to the display program 112 determining that the delta is not larger than the cache interval times the threshold (decision step 308, no branch), processing proceeds to step 310. Responsive to display program 112 determining the delta is larger than the cache interval times the threshold (decision step 308, yes branch), processing proceeds to step 312.

Display program 112 does not update (step 310). At step 310, display program 112 does not update the cached data. In an embodiment, display program 112 proceeds to step 302 to initiate workflow 300 again. In an embodiment, display program 112 may wait a time interval before proceeding to step 302.

Display program 112 determines the most recent data (step 312). At step 312, display program 112 determines the most recent data to be any data that has been updated since time T1, discussed in step 302. In other words, as discussed in step 302, if the data was updated at time T1, the data was analyzed at time T2, and the cache was updated at time T3, display program 112 determines any data that was updated after time T1 but before the determined current time in step 304. In an embodiment, display program 112 determines what updated data from data that is found in information repository 114 or any other storage device accessible by display program 112.

Display program 112 whether an incremental update of data can occur (step 314). At step 214, display program 112 determines whether the cache can be updated by analyzing the most recent data from step 312 and then adding the results to the cached data or if all of the data, including the most recent data, must be analyzed and then the cached data be replaced with the newly analyzed data. In an embodiment, some aggregation functions can be updated incrementally and some aggregation functions cannot be updated incrementally. For example, max, min, avg, count, and sum can be updated incrementally and countd, stdev, stdevp, var, and varp cannot be updated incrementally. For example, if the cached data is “select max(run_time) from tableA group by job_id”, then the cached data can be updated incrementally, because the program can gets the new maximum value between the cached data and the new data.) In another example, if the cached data is “select var(run_time) from tableA group by job_id”, then the cached data cannot be updated incrementally.]

Display program 112 calculates all data (step 316). At step 316, display program 112 organizes/analyzes/interprets all of the data for storing in the cache and potential display by display program 112 in subsequent steps. In an embodiment, display program 112 performs an aggregation on the determined data of step 204 to determine all of the granularities of data. For example, the received query is “Select avg(run_time) from tableA group by job_id, user_name, host_name.”, and a UDGG is defined as (job_id:high granularity, queue:medium granularity, cluster:low granularity). Display program 112 runs sql “Select avg(run_time) from tableA group by cluster, user_name, host_name” as the low granularity data, run sql “Select avg(run_time) from tableA group by queue, user_name, host_name” as the medium granularity data, run sql “Select avg(run_time) from tableA group by job_id, user_name, host_name” as the high granularity data.

Display program 112 determines update data (step 318). At step 318, display program 112 determines which data of the most recent data found in step 312 should be used in step 320. In an embodiment, the update data may be all of the data determined to be the most recent data in step 312.

Display program 112 calculates new data (step 320). At step 320, display program 112 organizes/analyzes/interprets the new data for updating the data in the cache and potential display by display program 112 in subsequent steps. In an embodiment, display program 112 performs an aggregation on the determined update data of step 318 to determine the all granularities of data. For example, the received query is “Select avg(run_time) from tableA group by job_id, user_name, host_name.”, and a UDGG is defined as (job_id:high granularity, queue:medium granularity, cluster:low granularity). Display program 112 runs sql “Select avg(run_time) from tableA group by cluster, user_name, host_name” as the low granularity data, run sql “Select avg(run_time) from tableA group by queue, user_name, host_name” as the medium granularity data, run sql “Select avg(run_time) from tableA group by job_id, user_name, host_name” as the high granularity data.

Display program 112 updates cache and last cache time (step 322). At step 216, display program 112 stores the analyzed data of step 316 or step 320 in information repository 114 or any other storage location accessible to display program 112. Additionally, display program 112 updates the last cache time for the data in information repository 114 or any other storage location accessible to display program 112.

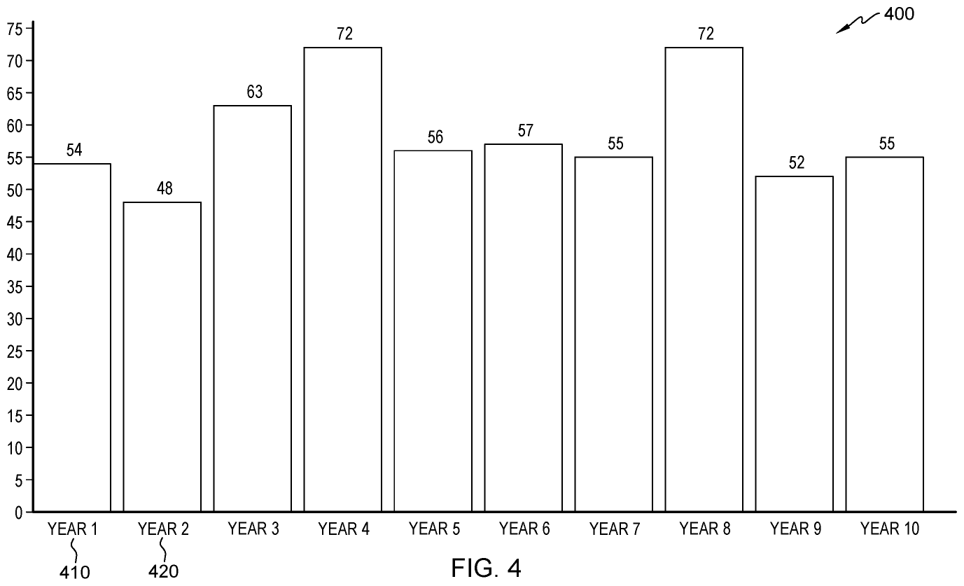

FIG. 4 is an example display of low granularity data 400, in accordance with at least one embodiment of the invention. In this example, a user has queried a data system to display sales data. Specifically, the user has asked the system to display the number of sales over a 10 year period. Display program 112 determines that there is both yearly data (low granularity data) and monthly data (high granularity data). In this example, display program 112 determines if there is low granularity data found in the cache that has been analyzed already to answer the query. Display program 112 determines there is low granularity data stored in the cache, receives this analyzed low granularity data, and displays the data as shown in FIG. 4. For example, display program 112 displays year 1 data 410, year 2 data 420, etc. Due to the high granularity data being stored in the cache, display program 112 can display the high granularity data quicker, relative to data that has not been analyzed and stored in the cache.

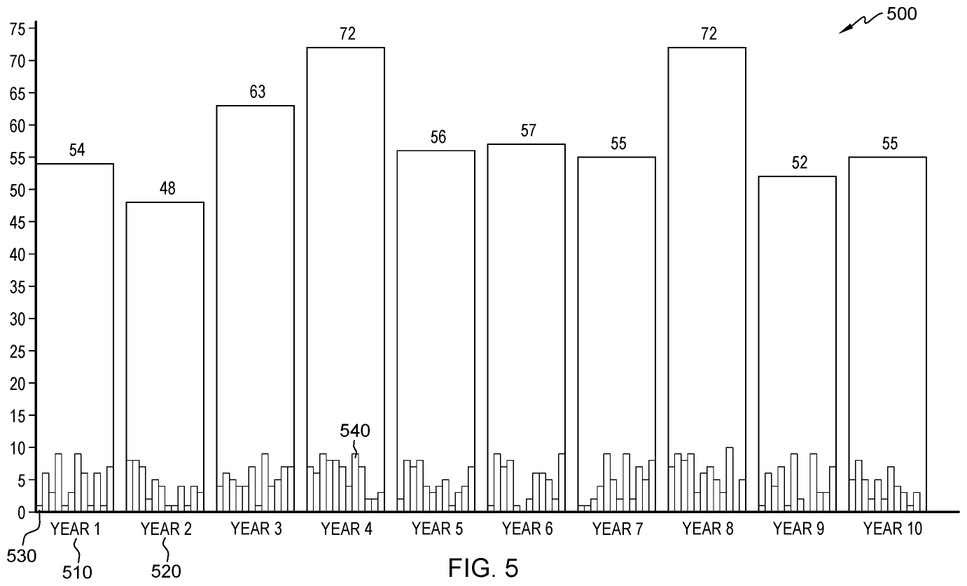

FIG. 5 is an example display of low granularity data and high granularity data 500, in accordance with at least one embodiment of the invention. In this example, the user has queried a data system to display sales data. As discussed in reference to the example in FIG. 4, the low granularity data has already been displayed quickly due to the low granularity data being found in the cache. Display program 112 then analyzes the monthly data (high granularity data) and then stores the high granularity data in the cache and also displays the data along with the yearly data. For example, display program 112 displays year 1 data 510, year 2 data 520, etc. This allows the user to quickly see the yearly data (low granularity data) and then as the monthly data (high granularity data) is analyzed it is displayed along with the yearly data.

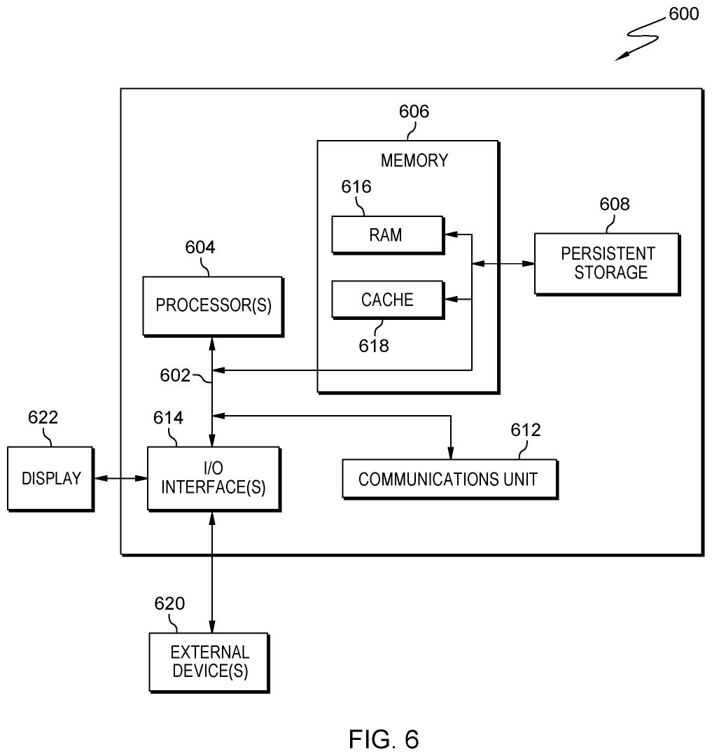

FIG. 6 is a block diagram depicting components of a computer 600 suitable for display program 112, in accordance with at least one embodiment of the invention. FIG. 6 displays the computer 600, one or more processor(s) 604 (including one or more computer processors), a communications fabric 602, a memory 606 including, a RAM 616, and a cache 618, a persistent storage 608, a communications unit 612, I/O interfaces 614, a display 622, and external devices 620. It should be appreciated that FIG. 6 provides only an illustration of one embodiment and does not imply any limitations with regard to the environments in which different embodiments may be implemented. Many modifications to the depicted environment may be made.

As depicted, the computer 600 operates over the communications fabric 602, which provides communications between the computer processor(s) 604, memory 606, persistent storage 608, communications unit 612, and input/output (I/O) interface(s) 614. The communications fabric 602 may be implemented with an architecture suitable for passing data or control information between the processors 604 (e.g., microprocessors, communications processors, and network processors), the memory 606, the external devices 620, and any other hardware components within a system. For example, the communications fabric 602 may be implemented with one or more buses.

The memory 606 and persistent storage 608 are computer readable storage media. In the depicted embodiment, the memory 606 comprises a random-access memory (RAM) 616 and a cache 618. In general, the memory 606 may comprise any suitable volatile or non-volatile one or more computer readable storage media.

Program instructions for display program 112 may be stored in the persistent storage 608, or more generally, any computer readable storage media, for execution by one or more of the respective computer processors 604 via one or more memories of the memory 606. The persistent storage 608 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of the persistent storage 608.

The communications unit 612, in these examples, provides for communications with other data processing systems or devices. In these examples, the communications unit 612 may comprise one or more network interface cards. The communications unit 612 may provide communications through the use of either or both physical and wireless communications links. In the context of some embodiments of the present invention, the source of the various input data may be physically remote to the computer 600 such that the input data may be received, and the output similarly transmitted via the communications unit 612.

The I/O interface(s) 614 allow for input and output of data with other devices that may operate in conjunction with the computer 600. For example, the I/O interface 614 may provide a connection to the external devices 620, which may be as a keyboard, keypad, a touch screen, or other suitable input devices. External devices 620 may also include portable computer readable storage media, for example thumb drives, portable optical or magnetic disks, and memory cards. Software and data used to practice embodiments of the present invention may be stored on such portable computer readable storage media and may be loaded onto the persistent storage 608 via the I/O interface(s) 614. The I/O interface(s) 614 may similarly connect to a display 622. The display 622 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for displaying data, the computer-implemented method comprising:
receiving, by one or more computer processors, a query on a data;
determining, by one or more computer processors, one or more granularity of data of the data to respond to the query, wherein the one or more granularity of data includes a low granularity data and a high granularity data;
determining, by one or more computer processors, whether the low granularity data is stored in a cache;
responsive to determining the low granularity data is stored in the cache, retrieving, by one or more computer processors, the low granularity data; and
displaying, by one or more computer processors, the low granularity data.

2. The computer-implemented method of claim 1, further comprising:
analyzing, by one or more computer processors, the data to determine the high granularity data;
storing, by one or more computer processors, the high granularity data in the cache; and
displaying, by one or more computer processors, at least part of the high granularity data with the displayed low granularity data.

3. The computer-implemented method of claim 1, further comprising:
responsive to determining the low granularity data is not stored in the cache, analyzing, by one or more computer processors, the data to determine the low granularity data and the high granularity data;
storing, by one or more computer processors, the low granularity data and the high granularity data in the cache; and
displaying, by one or more computer processors, at least part of the high granularity data with the displayed low granularity data.

4. The computer-implemented method of claim 1, further comprising:
determining, by one or more computer processors, a last cache time of the low granularity data stored in the cache;
determining, by one or more computer processors, a current time;
determining, by one or more computer processors, whether the difference between the last cache time and the current time is greater than a cache interval times a threshold; and
responsive to determining the difference between the last cache time and the current time is greater than the cache interval times the threshold, updating, by one or more computer processors, the low granularity data stored in the cache.

5. The computer-implemented method of claim 1, wherein updating, by one or more computer processors, the low granularity data stored in the cache comprises:
determining, by one or more computer processors, whether the low granularity data stored in the cache can be updated incrementally;
responsive to determining the low granularity data stored in the cache can be updated incrementally, determining, by one or more computer processors, an update data, wherein the update data is a new data added to the data since a time the low granularity data was analyzed;
analyzing, by one or more computer processors, the update data; and
adding, by one or more computer processors, the analyzed update data to the low granularity data stored in the cache.

6. The computer-implemented method of claim 1, wherein updating, by one or more computer processors, the low granularity data stored in the cache comprises:
determining, by one or more computer processors, whether the low granularity data stored in the cache can be updated incrementally;
responsive to determining, by one or more computer processors, the low granularity data stored in the cache cannot be updated incrementally, determining, a new data, wherein the new data has been added to the data since a time the low granularity data was analyzed;
analyzing, by one or more computer processors, the new data; and
replacing, by one or more computer processors, the low granularity data stored in the cache with the analyzed new data to become the low granularity data stored in the cache.

7. The computer-implemented method of claim 1, wherein the query can be performed by an aggregation function on the data.

8. A computer program product for displaying data, the computer program product comprising:
one or more computer readable storage media; and
program instructions stored on the one or more computer readable storage media, the program instructions comprising:
program instructions to receive a query on a data;
program instructions to determine one or more granularity of data of the data to respond to the query, wherein the one or more granularity of data includes a low granularity data and a high granularity data;
program instructions to determine whether the low granularity data is stored in a cache;
responsive to determining the low granularity data is stored in the cache, program instructions to retrieve the low granularity data; and
program instructions to display the low granularity data.

9. The computer program product of claim 8, further comprising one or more of the following program instructions, stored on the one or more computer readable storage media, to:
analyze the data to determine the high granularity data;
store the high granularity data in the cache; and
display at least part of the high granularity data with the displayed low granularity data.

10. The computer program product of claim 8, further comprising one or more of the following program instructions, stored on the one or more computer readable storage media, to:
responsive to determining the low granularity data is not stored in the cache, analyze the data to determine the low granularity data and the high granularity data;
store the low granularity data and the high granularity data in the cache; and
display at least part of the high granularity data with the displayed low granularity data.

11. The computer program product of claim 8, further comprising one or more of the following program instructions, stored on the one or more computer readable storage media, to:
determine a last cache time of the low granularity data stored in the cache;
determine a current time;
determine whether the difference between the last cache time and the current time is greater than a cache interval times a threshold; and
responsive to determining the difference between the last cache time and the current time is greater than the cache interval times the threshold, update the low granularity data stored in the cache.

12. The computer program product of claim 8, wherein program instructions to update the low granularity data stored in the cache comprise:
determine whether the low granularity data stored in the cache can be updated incrementally;
responsive to determining, by one or more computer processors, the low granularity data stored in the cache can be updated incrementally, determine an update data, wherein the update data is a new data added to the data since a time the low granularity data was analyzed;
analyzing, by one or more computer processors, the update data; and
adding, by one or more computer processors, the analyzed update data to the low granularity data stored in the cache.

13. The computer program product of claim 8, wherein program instructions to update the low granularity data stored in the cache comprise:
determine whether the low granularity data stored in the cache can be updated incrementally;
responsive to determining, by one or more computer processors, the low granularity data stored in the cache cannot be updated incrementally, determining, a new data, wherein the new data has been added to the data since a time the low granularity data was analyzed;
analyzing, by one or more computer processors, the new data; and
replacing, by one or more computer processors, the low granularity data stored in the cache with the analyzed new data to become the low granularity data stored in the cache.

14. The computer program product of claim 8, wherein the query can be performed by an aggregation function on the data.

15. A computer system for displaying data, the computer system comprising:
one or more computer processors;
one or more computer readable storage media; and
program instructions, stored on the one or more computer readable storage media for execution by at least one of the one or more computer processors, the program instructions comprising:
program instructions to receive a query on a data;
program instructions to determine one or more granularity of data of the data to respond to the query, wherein the one or more granularity of data includes a low granularity data and a high granularity data;
program instructions to determine whether the low granularity data is stored in a cache;
responsive to determining the low granularity data is stored in the cache, program instructions to retrieve the low granularity data; and
program instructions to display the low granularity data.

16. The computer system of claim 15, further comprising one or more of the following program instructions, stored on the one or more computer readable storage media for execution by at least one of the one or more computer processors, to:
analyze the data to determine the high granularity data;
store the high granularity data in the cache; and
display at least part of the high granularity data with the displayed low granularity data.

17. The computer system of claim 15, further comprising one or more of the following program instructions, stored on the one or more computer readable storage media for execution by at least one of the one or more computer processors, to:
responsive to determining the low granularity data is not stored in the cache, analyze the data to determine the low granularity data and the high granularity data;
store the low granularity data and the high granularity data in the cache; and
display at least part of the high granularity data with the displayed low granularity data.

18. The computer system of claim 15, further comprising one or more of the following program instructions, stored on the one or more computer readable storage media for execution by at least one of the one or more computer processors, to:
determine a last cache time of the low granularity data stored in the cache;
determine a current time;
determine whether the difference between the last cache time and the current time is greater than a cache interval times a threshold; and
responsive to determining the difference between the last cache time and the current time is greater than the cache interval times the threshold, update the low granularity data stored in the cache.

19. The computer system of claim 15, wherein program instructions to update the low granularity data stored in the cache comprise:
determine whether the low granularity data stored in the cache can be updated incrementally;
responsive to determining, by one or more computer processors, the low granularity data stored in the cache can be updated incrementally, determine an update data, wherein the update data is a new data added to the data since a time the low granularity data was analyzed;
analyzing, by one or more computer processors, the update data; and
adding, by one or more computer processors, the analyzed update data to the low granularity data stored in the cache.

20. The computer system of claim 15, wherein program instructions to update the low granularity data stored in the cache comprise:
determine whether the low granularity data stored in the cache can be updated incrementally;
responsive to determining, by one or more computer processors, the low granularity data stored in the cache cannot be updated incrementally, determining, a new data, wherein the new data has been added to the data since a time the low granularity data was analyzed;
analyzing, by one or more computer processors, the new data; and
replacing, by one or more computer processors, the low granularity data stored in the cache with the analyzed new data to become the low granularity data stored in the cache.
